(19) United States
(12) Patent Application Publication
(10) Pub. No.: US 2014/0172910 A1
(43) Pub. Date: Jun. 19, 2014

(54) MUSIC RECOMMENDATION SYSTEM AND METHOD FOR VEHICLE

(71) Applicant: Hyundai Motor Company, Seoul (KR)

(72) Inventors: Woochul Jung, Seoul (KR); Young Woo Choi, Incheon (KR)

(73) Assignee: Hyundai Motor Company, Seoul (KR)

(21) Appl. No.: 14/082,791

(22) Filed: Nov. 18, 2013

(30) Foreign Application Priority Data
Dec. 13, 2012 (KR) 10-2012-0145727

(51) Int. Cl. G06F 17/30

(52) U.S. Cl. CPC G06F 17/30749
USPC 707/769

(57) ABSTRACT

A music recommendation system and method is provided and include a processor that is configured to collect kinetic information and control information of a vehicle. In addition, the processor is configured to generate stress information of a driver by processing the kinetic information and the control information and extract physical properties of a music by performing an audio signal process on the a music file and extract an emotional property that corresponds to the physical properties of the music. The processor is further configured to connect and store the music information of the music file and the emotional property of the music and search music that corresponds to the stress information to recommend the music for the driver.

### CROSS-REFERENCE TO RELATED APPLICATION

This application claims priority to and the benefit of Korean Patent Application No. 10-2012-0145727 filed in the Korean Intellectual Property Office on Dec. 13, 2012, the entire contents of which are incorporated herein by reference.

### BACKGROUND

(a) Field of the Invention

The present invention relates to a music recommendation system and method for a vehicle. More particularly, the present invention relates to a music recommendation system and method that reduce stress of a driver.

(b) Description of the Related Art

In general, vehicles are driven under more strain during severe weather conditions such as snow, rain, and fog. Further, drivers may be more strained in a stagnation area due to repeated acceleration and deceleration and driver stress may also be due to fatigue when driving for extended periods of time. Additionally, drivers may be stressed when a sudden stop is repeated due to measures taken against the danger of an accident.

Moreover, an increase in stress may increase the risk of an accident. A typical device used to alleviate driver stress is the use of the audio system. In particular, stress generated during driving may be reduced by listening to radio from the audio system or listening to music stored in a storage medium while driving. Drivers may further reduce stress by listening to music suitable for their feeling, that is, the stress state. However, the stress state of drivers is not considered in the radio programs or the music in the storage medium. Therefore, music should be provided that is suitable for the stress state of drivers in consideration of the stress state.

The above information disclosed in this section is only for enhancement of understanding of the background of the invention and therefore it may contain information that does not form the prior art that is already known in this country to a person of ordinary skill in the art.

### SUMMARY

The present invention provides a music recommendation system and method for a vehicle that provides music suitable for the stress state of drivers.

An exemplary embodiment of the present invention provides a music recommendation system that may include a vehicle information collecting unit that collects kinetic information and control information of a vehicle; a client sensor data managing unit that generates stress information of a driver by processing the kinetic information and the control information; an emotion-meta analyzing unit that extracts physical properties of music by performing an audio signal process on a music file and extracts an emotional property that corresponds to the physical properties of the music; a music recommendation-meta database (DB) managing unit that connects and stores the music information of the music file and the emotional property of the music; and a stress reduction music recommending unit that searches music that corresponds to the stress information from the music recommendation-meta DB managing unit and recommends the music for the driver.

The client sensor data managing unit may include: a message formatting unit that generates conversion data by converting the kinetic information and the control information into a predetermined format; a context managing unit that classifies the conversion data based on stress determination standards and abstracts the conversion data into state values for stress determination; and a stress determining unit that determines whether the state values correspond to a stress state, and generates the stress information including the type and the intensity of the stress which are indicated by the state values.

The system may further include a surrounding information collecting unit that collects weather information including at least any one of rainfall and external temperature, and the client sensor data managing unit may be configured to generate the stress information by processing the weather information. In addition, the music recommendation-meta DB managing unit may include: a music information DB that stores the music information; and an emotion-meta DB that stores the emotional properties of music. The emotion-meta analyzing unit may be disposed in an emotion-meta analyzing server connected with the vehicle via wireless communication.

Furthermore, the system may further include a communication interface that provides a wireless communication interface between the music recommendation-meta DB managing unit and the emotion-meta analyzing server. The system may further include a music play log storing unit that stores the stress state of the driver, music recommended based on the stress state, and feedback information of the driver.

Another exemplary embodiment of the present invention provides a music recommendation method that may include collecting weather information, kinetic information and control information of a vehicle to determine the stress state of a driver; generating conversion data by converting the weather information, and the kinetic information and the control information of a vehicle into a predetermined format; abstracting the conversion data into a state value for stress determination, and determining whether stress based on the state value is detected; generating stress information that includes the type and the intensity of stress indicated by the state value, when the stress based on the state value is detected; and recommending music that corresponds to the stress information for the driver.

The recommending of music that corresponds to the stress information for the driver may include: determining the emotional property of the music that corresponds to the type and the intensity of the stress; and searching music with the emotional property from a music recommendation-meta DB managing unit and then recommending the music for the driver. The generating of stress information may include: classifying the type of the stress by checking the state value of the conversion data; and classifying the intensity of the stress for each type of stress by checking the state value of the conversion data.

Another exemplary embodiment of the present invention provides a method of generating emotion-meta information of a music file in a music recommendation system that recommends music based on the stress state of a driver and the method may include: inputting the music file; extracting physical properties including at least any one of the tempo and the number of bits of music in the music file; extracting an emotional property of the music that corresponds to the physical properties; and mapping the emotional property of the music as emotion-meta information of the music file into the music file.

### BRIEF DESCRIPTION OF THE DRAWINGS

FIG. 1 is an exemplary block diagram illustrating a music recommendation system for a vehicle according to an exemplary embodiment of the present invention;

FIG. 2 is an exemplary flowchart illustrating a method of operating a music recommendation system for a vehicle according to an exemplary embodiment of the present invention;

FIG. 3 is an exemplary flowchart illustrating a method of operating a music recommendation system for a vehicle according to another exemplary embodiment of the present invention;

FIG. 4 is an exemplary block diagram illustrating a music recommendation system for a vehicle according to another exemplary embodiment of the present invention;

FIG. 5 is an exemplary flowchart illustrating a method of operating a music recommendation system for a vehicle according to another exemplary embodiment of the present invention; and

FIG. 6 is an exemplary flowchart illustrating a method of operating a music recommendation system for a vehicle according to another exemplary embodiment of the present invention.

### DESCRIPTION OF SYMBOLS

| | |
|---|---|
| 100: Music recommendation system | 110: Data collecting unit |
| 111: Surrounding information collecting unit | |
| 112: Vehicle information collecting unit | |
| 113: Client sensor data managing unit | |
| 114: Message formatting unit | 115: Context managing unit |
| 116: Stress determining unit | |
| 120: Music analyzing/recommending unit | |
| 121: Media managing unit | |
| 122: Emotion-meta analyzing unit | |

123: Music recommendation-meta DB managing unit

| | |
|---|---|
| 124: Music information DB | 125: Emotion-meta DB |
| 126: Stress reduction music recommending | |
| unit | |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings such that those skilled in the art can easily achieve the present invention. The present invention may be disposed in various ways and is not limited to the exemplary embodiments described herein. Further, in the following exemplary embodiments, the components having the same configuration are designated by the same reference numerals and described in the first exemplary embodiment, and only other configurations different from the first exemplary embodiment are described in the other exemplary embodiments. The unrelated parts to the description of the exemplary embodiments are not shown to make the description clear and like reference numerals designate like element throughout the specification.

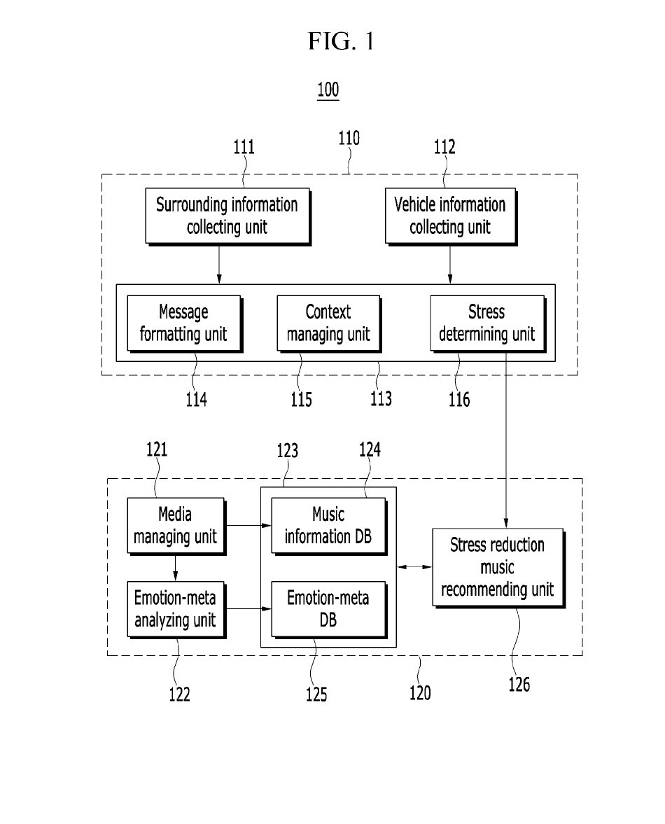

FIG. 1 is an exemplary block diagram illustrating a music recommendation system for a vehicle according to an exemplary embodiment of the present invention. Referring to FIG. 1, a music recommendation system 100 may include a plurality of units executed by a processor. The plurality of units may include a data collecting unit 110 configured to collect data to determine a stress state of a driver and a music analyzing/recommending unit 120 configured to analyze the type of music and recommend music suitable for the stress state.

In particular, the data collecting unit 110 may include a surrounding information collecting unit 111, a vehicle information collecting unit 112, and a client sensor data managing unit 113. The surrounding information collecting unit 111 may be configured to collect weather information such as snow, rain, fog, and external temperature in real time. The weather information that may influence driving may be collected by a rainfall sensor and a temperature sensor etc. mounted within a vehicle. Alternatively, the surrounding information collecting unit 111 may be provided with weather information via wireless communication from a web server that provides weather information.

In addition, the vehicle information collecting unit 112 may be configured to collect in real time the kinetic information including the traveling speed, the traveling time, and the RPM (Revolution Per Minute) of a vehicle and the control information including the state of the engine, the state of the indoor lamps, and the operation state of the wipers in the vehicle. Further, the vehicle information collecting unit 112 may be configured to collect content use information such as the radio and the music source that the driver listened to and the operation of a navigation system.

The client sensor data managing unit 113 may be configured to generate stress information of the driver by processing the weather information, and the kinetic information and the control information of the vehicle. The client sensor data managing unit 113 may include a message formatting unit 114, a context managing unit 115, and a stress determining unit 116.

The message formatting unit 114 may be configured to generate conversion data by converting the information collected by the surrounding information collecting unit 111 and the vehicle information collecting unit 112 into a format set in the type available for the stress determining unit 116. The message formatting unit 114 may be configured to convert data received via a vehicle network such as CAN (Controller Area Network) into a format available for the stress determining unit 116.

The context managing unit 115 may be configured to classify and manage the conversion data as context based on stress determination standards. Additionally, the context managing unit 115 may be configured to classify and manage the collected conversion data into accumulated traveling time, sudden deceleration, sudden acceleration, economical driving time, overspeed time, low-speed time, brake, rainfall, and external temperature. The context managing unit 115 may also be configured to abstract the conversion data into state values for stress determination.

The stress determining unit 116 may be configured to determine whether the current state value for the driver corresponds to the stress state by analyzing the state value abstracted by the context managing unit 115. The stress determining unit 116 may further be configured to determine the type and intensity of the stress indicated by the state value, when the state value for the driver corresponds to the stress state. The stress determining unit 116 may be configured to generate stress information including the type and intensity of the stress of the driver and transmit the stress information to the music analyzing/recommending unit 120.

Furthermore, the music analyzing/recommending unit 120 may include a media managing unit 121, an emotion-meta analyzing unit 122, a music recommendation-meta DB managing unit 123, and a stress reduction music recommending unit 126.

In particular, the media managing unit 121 may be configured to manage a vehicle terminal to play music or other media devices to output multimedia contents. The media managing unit 121 may be configured to transmit the music files played by the vehicle terminal or other media devices to the emotion-meta analyzing unit 122 and the music recommendation-meta DB managing unit 123. Music information such as the title of music, the name of an artist, and the running time may be included in the music files.

The emotion-meta analyzing unit 122 may be configured to extract the physical properties of music by performing an audio signal process on the music file and extract the emotional property that corresponds to the physical properties of the music. The physical properties of music and the corresponding emotional property of the music may be expressed by quantified values. For example, the physical properties of music may be the tempo or the number of average bits of the music and the corresponding emotional property of the music may be set to a specific value that indicates light music, exciting music, calm music, jaunty music, fast music, and symphonic music.

The music recommendation-meta DB managing unit 123 may include a music information DB 124 configured to store the music information transmitted from the media managing unit 121 and an emotion-meta DB 125 configured to store the emotion-meta information that relates to the emotional property of music extracted from the music files. The music recommendation-meta DB managing unit 123 may be configured to store the music information in the music information DB 124 and the emotional property in the emotion-meta DB 125 in connection with each other.

The stress reduction music recommending unit 126 may be configured to receive the stress information from the stress determining unit 116, and search music that corresponds to the stress information from the music recommendation-meta DB managing unit 123 and recommend the music for the driver. Alternatively, the stress reduction music recommending unit 126 may output the searched music by transmitting the searched music that corresponds to the stress information of the driver to the media managing unit 121.

As described above, music suitable for the stress state of a driver which is generated during driving may be recommended for the driver to reduce a stress level of the driver. The process of generating the emotion-meta information of a music file in the music recommendation system 100 is described hereafter.

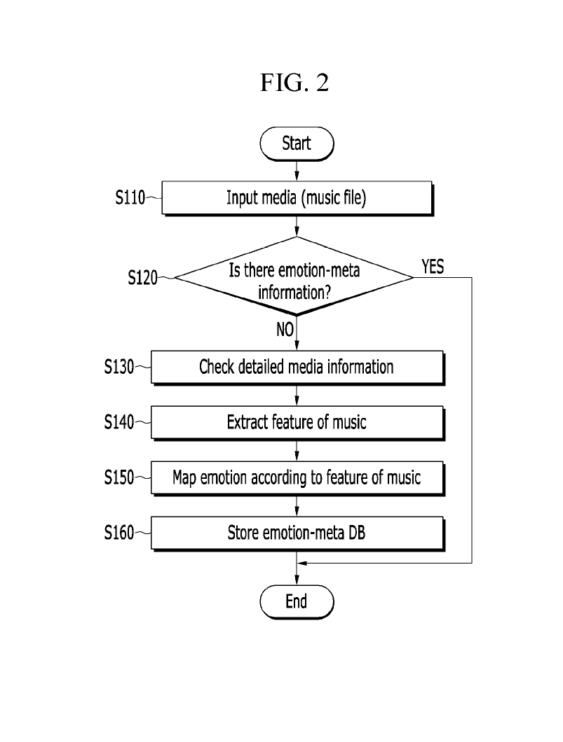

FIG. 2 is an exemplary flowchart illustrating a method of operating a music recommendation system for a vehicle according to an exemplary embodiment of the present invention. Referring to FIG. 2, in the music recommendation system 100 that is executed by a processor, a media (e.g., a music file) may be input to the media managing unit 121 (S110). The media managing unit 121 may be configured to determine whether the music information that corresponds to the input music file is in the music information DB 124. The media managing unit 121 may be configured to store music information on the input music file into the music information DB 124, when there is no music information for the input music file in the music information DB 124. The media managing unit 121 may be configured to transmit the input music file to the emotion-meta analyzing unit 122.

The emotion-meta analyzing unit 122 may be configured to determine whether emotion-meta information corresponds to the input music file (S120). In other words, the emotion-meta analyzing unit 122 may be configured to determine whether emotion-meta information corresponds to the input music file in the emotion-meta DB 125. Further, the emotion-meta analyzing unit 122 may be configured to check the detailed information of the media such as the title of music, the name of an artist, and the running time from the input music file (S130). The emotion-meta analyzing unit 122 may be configured to extract the features of the music in the input music file (S140). In other words, the emotion-meta analyzing unit 122 may be configured to extract the physical properties such as the tempo and the number of bits of the music

Additionally, the emotion-meta analyzing unit 122 may be configured to map the emotion based on the music features (S150). The emotion-meta analyzing unit 122 may be configured to extract the emotional property of the music that corresponds to the physical properties such as the tempo and the number of bits of music and map the emotional property to the corresponding music file. The emotional property of music may indicate any one of light music, exciting music, calm music, jaunty music, fast music, and symphonic music. The emotional property may be the emotion-meta information of the music file.

The emotion-meta analyzing unit 122 may further be configured to store the emotional property of music extracted based on the input music file into the emotion-meta DB 125 (S160). The emotional property of music stored in the emotion-meta DB 125 may be associated with the music information stored in the music information DB 124. In other words, the emotion-meta information of the input music file may be generated based on the music information in the emotion-meta DB 125.

As described above, when a new music file is input, the music recommendation system 100, as executed by the processor, may be configured to store music information into the music information DB 124, analyze the emotional property that corresponds to the music information, and store emotion-meta information into the emotion-meta DB 125. The music recommendation system 100 may be configured to recommend music suitable for the stress state of a driver based on the information stored in the music information DB 124 and the emotion-meta DB 125. The process of recommending music suitable for the stress state of a driver based on the information stored in the music information DB 124 and the emotion-meta DB 125 is described hereafter.

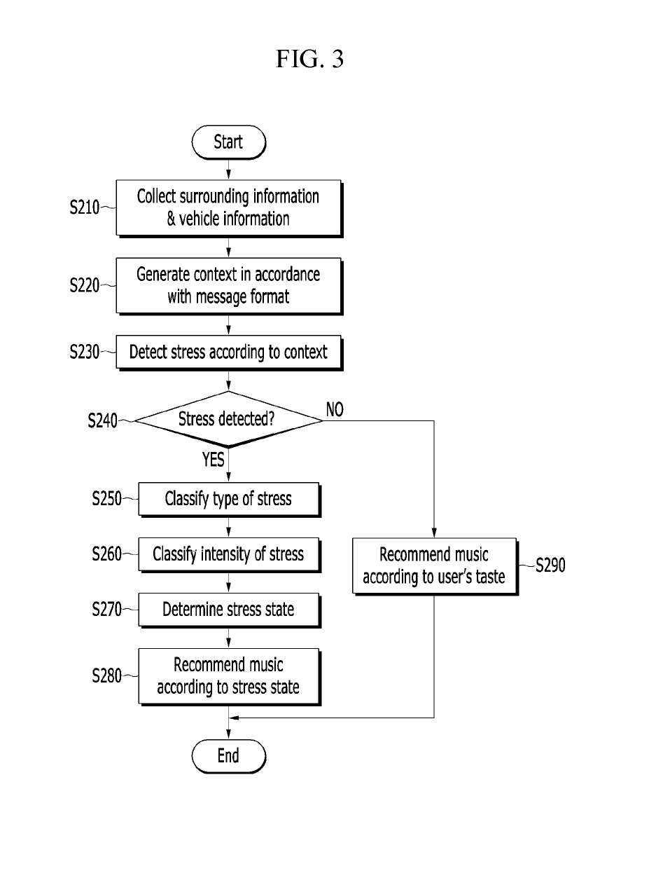

FIG. 3 is an exemplary flowchart illustrating a method of operating a music recommendation system for a vehicle according to another exemplary embodiment of the present invention. Referring to FIG. 3, surrounding information of a vehicle may be collected by the surrounding information collecting unit 111 and vehicle information may be collected by the vehicle information collecting unit 112 (S210). The surrounding information of a vehicle may include weather information such as snow, rain, fog, and external temperature. The vehicle information may include the kinetic information including the traveling speed, the traveling time, and the RPM of a vehicle and the control information may include the state of the engine, the state of the indoor lamps, and the operation state of the wipers in the vehicle.

The message formatting unit 114 may be configured to generate context by converting the surrounding information and the vehicle information into a predetermined type of message format (S220). The context managing unit 115 may be configured to manage the context as an abstracted state value that indicates at least any one of the accumulated traveling time, sudden deceleration, sudden acceleration, normal driving time, overspeed time, low-speed time, brake, rainfall, and external temperature.

The stress determining unit 116 may be configured to detect stress based on the above context (S230). In particular, the stress determining unit 116 may be configured to determine whether stress is detected based on the context (S240). For example, when the total driving time is about 40 minutes or greater and the traveling distance is about 20 km or greater based on the state value of the context, the stress determining unit 116 may be configured to determine that stress is detected due to accumulation of fatigue in driving. When the economical driving time is below a predetermined time (e.g., substantially short) and the low-speed time is maintained for about 5 minutes or greater based on the context state value, the stress determining unit 116 may be configured to determine that stress is detected due to stagnation. When rainfall is detected or the external temperature is about 4 degrees Celsius or less or 28 degrees Celsius or greater based on the context state value, the stress determining unit 116 may be configured to determine that stress is detected due to the weather. When the overspeed time is about 5 minutes or greater, braking is performed about five times or more per minute, or there is sudden deceleration or sudden acceleration, the stress determining unit 116 may be configured to determine that stress is detected due to tension.

The stress determining unit 116 may be configured to classify the types of stress (S250). The types of stress may be stress due to accumulation of fatigue during driving, stress due to stagnation, stress due to weather, and stress due to tension. The stress determining unit 116 may be configured to classify the types of stress by checking the state value of the context. In addition, the stress determining unit 116 may be configured to classify the intensity of stress (S260). The intensity of stress may be classified based on predetermined standards for each type of stress. The stress determining unit 116 may be configured to classify the intensity of stress by checking the state value of the context. Further, the stress determining unit 116 may be configured to determine the stress state of the driver (S270). In other words, the stress determining unit 116 may be configured to determine the type and the intensity of the stress. The stress determining unit 116 may be configured to determine two or more types of stress and the intensity. The stress determining unit 116 may be configured to generate stress information that includes the type and the intensity of stress and transmit the stress information to the stress reduction music recommending unit 126.

The stress reduction music recommending unit 126 may be configured to detect music that corresponds to the stress state of the driver from the music recommendation-meta DB managing unit 123 and recommend the music to the driver (S280). In other words, the stress reduction music recommending unit 126 may be configured to recommend music that corresponds to the stress information for the driver. The stress reduction music recommending unit 126 may be configured to determine the emotional property of music based on the type and intensity of stress, search music with the emotional property from the music recommendation-meta DB managing unit 123, and recommend the music for the driver.

For example, when the type of stress of the driver is based on accumulation of fatigue during driving, jaunty music may be recommended. When the type of stress of the driver is based on stagnation, exciting music may be recommended. When the type of stress of the driver is based on weather, music suitable for the mood of the weather may be recommended. When the type of stress of the driver is based on tension, calm music or classic music may be recommended. Music classified in detail in the same type of music may be recommended, depending on the intensity of the stress of the driver. For example, when jaunty music is recommended, corresponding to stress due to accumulation of fatigue during driving, the degree of jauntiness may be classified and corresponding music may be recommended based on the intensity of the stress.

Additionally, in response to detecting no stress in the process (S240) of determining whether stress is detected based on context, the stress determining unit 116 may be configured to transmit the content use information by the driver to the stress reduction music recommending unit 126 and the stress reduction music recommending unit 126 may be configured to recommend music that corresponds to the user's taste based on the content use information (S290).

The music recommendation system 100 may be mounted within a vehicle, but some of the music recommendation system 100 may be disposed within a server that may be configured to perform wireless communication with the vehicle. The case when some of the music recommendation system 100 is disposed in a server is described hereafter.

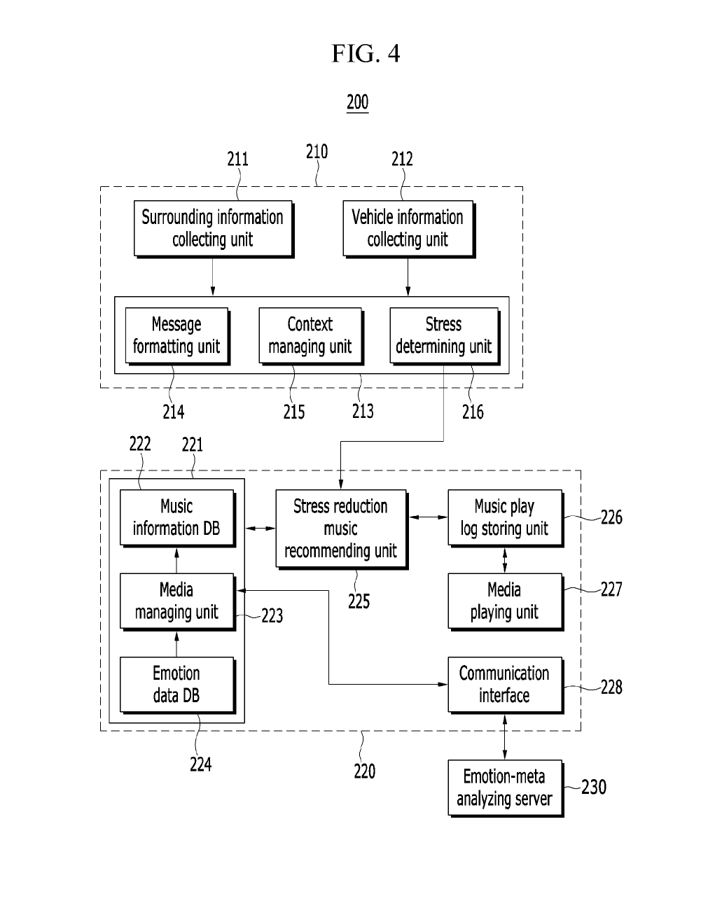

FIG. 4 is an exemplary block diagram illustrating a music recommendation system for a vehicle according to another exemplary embodiment of the present invention. Referring to FIG. 4, a music recommendation system 200 may include a plurality of units executed by a processor. The plurality of units may include a data collecting unit 210 configured to collect data for determining the stress state of a driver, a music recommending unit 220 configured to recommend music suitable for the stress state, and an emotion-meta analyzing server 230. The data collecting unit 210 and the music recommending unit 220 may be disposed within a vehicle and the emotion-meta analyzing server 230 may be disposed on a server connected with the vehicle via a network.

The data collecting unit 210 may include a surrounding information collecting unit 211, a vehicle information collecting unit 212, and a client sensor data managing unit 213. The client sensor data managing unit 213 may include a message formatting unit 214, a context managing unit 216, and a stress determining unit 216. The data collecting unit 210 is the same as the data collecting unit 110 described with reference to FIG. 1 and the detailed description is therefore omitted.

The music recommending unit 220 may include a music recommendation-meta DB managing unit 221, a stress reduction music recommending unit 225, a music play log storing unit 226, a media playing unit 227, and a communication interface 228. The communication interface 228 may be configured to provide a wireless communication interface between the music recommendation-meta DB managing unit 221 and the emotion-meta analyzing server 230. The music recommendation-meta DB managing unit 221 may include a music information DB 222, a media managing unit 223, and an emotion-meta DB 224.

The media managing unit 223 may be configured to manage a vehicle terminal to play music or other media devices to play multimedia content. The media managing unit 223 may be configured to transmit the music files played by the vehicle terminal or other media devices to the emotion-meta analyzing server 230 via the communication interface 228. Further, the media managing unit 223 may be configured to receive the emotional property of the music analyzed in the emotion-meta analyzing server 230 via the communication interface 228.

Additionally, the media managing unit 223 may be configured to transmit the music information included in the music file such as the title of music, the name of an artist, and the running time to the music information DB 222 and transmit the emotional property of the music analyzed in the emotion-meta analyzing server 230 to the emotion-meta DB 224. In other words, the media managing unit 223 may be configured to store the emotional property into the emotion-meta DB 224 in connection with the music information stored in the music information DB 222. The media managing unit 223 may be configured to manage a vehicle terminal to play music or other media devices to play multimedia contents.

The stress reduction music recommending unit 225 may be configured to receive the stress information from the stress determining unit 216, and search music that corresponds to the stress information from the music recommendation-meta DB managing unit 221 and recommend the music for the driver. Alternatively, the stress reduction music recommending unit 225 may be configured to search the music that was played based on the stress state of the driver in the music play log storing unit 226 and then output the music via the media playing unit 227. The music play log storing unit 226 may be configured to store context showing the stress state of the driver, the music recommended or played based on the stress state, and feedback information of the driver. The music play log storing unit 226 may be configured to store preferred music that the driver plays frequently.

The emotion-meta analyzing server 230 may be configured to extract the physical properties of music by processing the music file transmitted from the music recommending unit 220 and extract emotional property that corresponds to the physical properties of the music. The emotion-meta analyzing server 230 may be configured to transmit the emotional property extracted from the music file to the music recommending unit 220.

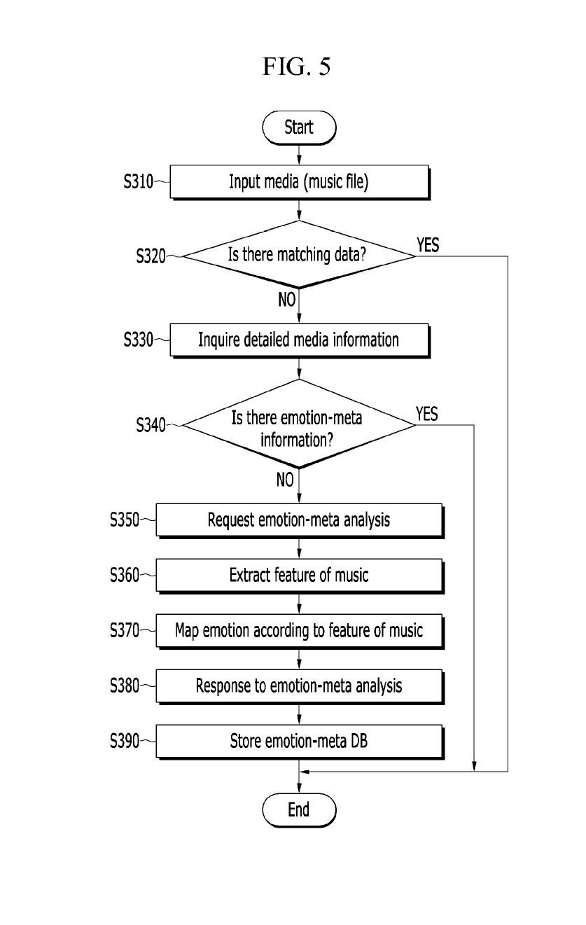

FIG. 5 is an exemplary flowchart illustrating a method of operating a music recommendation system for a vehicle according to another exemplary embodiment of the present invention. Referring to FIG. 5, in the music recommendation system 200, a media (e.g., music file) may be input to the media managing unit 223 by the processor (S310). Specifically, the media managing unit 223 may be configured to determine whether there is matching data that corresponds to the input music file (S320). The media managing unit 223 may be configured to check whether the music information (e.g., matching data) that corresponds to the input music file is in the music information DB 222.

When there is no music information that corresponds to the input music file in the music information DB 222, the media managing unit 223 may be configured to connect with a music source that manages a substantial amount of music files, and inquires the detailed media information that corresponds to the input music file (S330). The detailed media information may include the title of music, the name of an artist, and the running time of the music file.

The media managing unit 223 may be configured to determine whether emotion-meta information that corresponds to the input music file is in the emotion-meta DB 224 (S340). When emotion-meta information that corresponds to the input music file is not in the emotion-meta DB 224, the media managing unit 223 may be configured to request the emotion-meta analyzing server 230 to perform emotion-meta analysis on the input music file via the communication interface 228 (S350). The media managing unit 223 may be configured to transmit the input music file to the emotion-meta analyzing server 230.

The emotion-meta analyzing server 230 may be configured to extract the features of music, using the input music file (S360). In other words, the emotion-meta analyzing server 230 may be configured to extract the physical properties such as the tempo and the number of bits of the music. The emotion-meta analyzing server 230 may be configured to map the emotion according to the features of music (S370). In addition, the emotion-meta analyzing server 230 may be configured to extract the property values of music that corresponds to the physical properties such as the tempo and the number of bits of the music. The property values of music may indicate any one of light music, exciting music, calm music, jaunty music, fast music, and symphonic music.

The emotion-meta analyzing server 230 may be configured to transmit an emotion-meta analysis response that includes the property values of the music to the media managing unit 223, after finishing the emotion-meta analysis on the input music file (S380). The media managing unit 223 may be configured to store the property values of the music analyzed from the input music file into the emotion-meta DB 224 (S390). The property values of music stored in the emotion-meta DB 224 may be associated with the music information stored in the music information DB 222.

As described above, the emotion-meta analyzing server 230 may be disposed separately and may be configured to analyze the emotion-meta information in the input music file. Components other than the emotion-meta analyzing server 230 of the music recommendation system 200 may be disposed in a separate server. The functions of the components may be inferred from the above description in this case too.

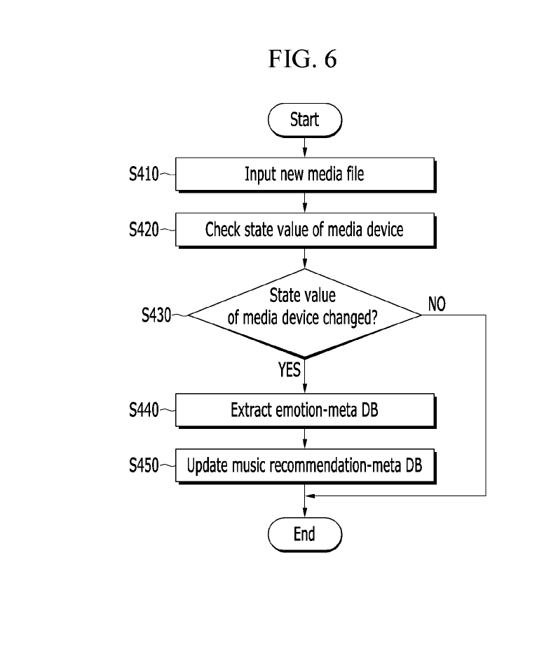

FIG. 6 is an exemplary flowchart illustrating a method of operating a music recommendation system for a vehicle according to another exemplary embodiment of the present invention. Referring to FIG. 6, the physical medium by which music files may be input to a vehicle terminal to play music or other media devices may vary and may include a compact disc (CD), MP3, hard disk, and USB memory. A method of managing the music information of music files for the physical media, using the media managing unit 121 shown in FIG. 1 or the media managing unit 223 shown in FIG. 4 is described hereafter.

A new media file may be input via any one of a plurality of physical media (S410). The state value of the media device that plays the new media file may be checked by a processor (S420). The state value of the media device may include lists for each physical medium that are arranged for each physical medium, such as the number of tracks, the latest play state, main tracks, the latest play music, the number of folders, and the running time that are stored on the CD, MP3, hard disk, or USB memory. As the new media file is input, the processor may be configured to determine whether to change the state value of the media device (S430). In other words, the processor may be configured to determine whether the new media file is the media file recorded in the lists for each physical medium.

When the new media file is not the media file recorded in the lists for each physical medium, the state value of the media device that plays the new media file may be changed, that is, updated. When the state value of the media device is changed, an emotion-meta DB that corresponds to the media device that plays the new media file may be extracted (S440). When the emotional property of the new media file is analyzed and emotion-meta information is generated, the music recommendation-meta DB that includes the music information DB and the emotion-meta DB may be updated (S450).

As described above, according to an exemplary embodiment of the present invention, it may be possible to provide music suitable for the stress state of a driver, and therefore, it may be possible to reduce the stress of a driver more effectively and to reduce the danger of an accident due to the stress of the driver.

The drawings referred to above and the detailed description of the present invention, provided as examples of the present invention, are used to explain the present invention, not limit meanings or the scope of the present invention described in claims. Therefore, those skilled in the art should understand that various modifications and other equivalent exemplary embodiments are possible. Therefore, the actual technical protection scope of the present invention should be determined by the spirit described in claims.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. A music recommendation system for a vehicle, comprising:
a processor coupled to the network interfaces and adapted to execute one or more processes; and
a memory configured to store a process executable by the processor, the process when executed operable to:
collect kinetic information and control information of a vehicle;
generate stress information of a driver by processing the kinetic information and the control information;
extract physical properties of music by performing an audio signal process on a music file;
extract an emotional property that corresponds to the physical properties of the music;
connect and store the music information of the music file and the emotional property of the music; and
search music that corresponds to the stress information and recommend the music for the driver.

2. The system of claim 1, wherein the program instructions when executed are further configured to:
generate conversion data by converting the kinetic information and the control information into a predetermined format;
classify the conversion data based on stress determination standards;
abstract the conversion data into state values for stress determination;
determine whether the state values correspond to a stress state; and
generate the stress information that includes a type and an intensity of the stress which are indicated by the state values.

3. The system of claim 1, wherein the program instructions when executed are further configured to:
collect weather information including at least any one of rainfall and external temperature,
wherein the stress information in generated by processing the weather information.

4. The system of claim 1, wherein the program instructions when executed are further configured to:
store the music information in a music information database; and
store the emotional properties of music in an emotion meta database.

5. The system of claim 1, wherein the processor is disposed in an emotion-meta analyzing server connected with the vehicle via wireless communication.

6. The system of claim 5, wherein further comprising:
a communication interface that provides a wireless communication interface between the processor and the emotion-meta analyzing server.

7. The system of claim 5, wherein the program instructions when executed are further configured to:
store the stress state of the driver, music recommended based on the stress state, and feedback information of the driver in a music play log storing unit.

8. A music recommendation method, comprising:
collecting, by a processor, weather information, kinetic information and control information of a vehicle to determine a stress state of a driver;
generating, by the processor, conversion data by converting the weather information, and the kinetic information and the control information of a vehicle into a predetermined format;
abstracting, by the processor, the conversion data into a state value for stress determination;
determining, by the processor, whether stress according to the state value is detected;
generating, by the processor, stress information that includes a type and an intensity of stress indicated by the state value, when the stress according to the state value is detected; and
recommending, by the processor, music that corresponds to the stress information for the driver.

9. The method of claim 8, wherein the recommending of music that corresponds to the stress information for the driver includes:
determining, by the processor, an emotional property of the music that corresponds to the type and the intensity of the stress; and
searching, by the processor, music with the emotional property from a music recommendation-meta DB managing unit and recommending the music for the driver.

10. The method of claim 8, wherein the generating of stress information includes:
classifying, by the processor, the type of the stress by checking the state value of the conversion data; and
classifying, by the processor, the intensity of the stress for each type of stress by checking the state value of the conversion data.

11. A method of generating emotion-meta information of a music file in a music recommendation system that recommends music based on the stress state of a driver, the method comprising:
receiving, by a processor, the music file;
extracting, by the processor, physical properties that include at least any one of the tempo and the number of bits of music in the music file;
extracting, by the processor, an emotional property of the music that corresponds to the physical properties; and
mapping, by the processor, the emotional property of the music as emotion-meta information of the music file into the music file.

12. A non-transitory computer readable medium containing program instructions executed by a processor, the computer readable medium comprising:
program instructions that collect weather information, kinetic information and control information of a vehicle to determine a stress state of a driver;
program instructions that generate conversion data by converting the weather information, and the kinetic information and the control information of a vehicle into a predetermined format;
program instructions that abstract the conversion data into a state value for stress determination;
program instructions that determine whether stress according to the state value is detected;
program instructions that generate stress information that includes a type and an intensity of stress indicated by the state value, when the stress according to the state value is detected; and
program instructions that recommend music that corresponds to the stress information for the driver.

13. The non-transitory computer readable medium of claim 12, further comprising:
program instructions that determine an emotional property of the music that corresponds to the type and the intensity of the stress; and
program instructions that search music with the emotional property from a music recommendation-meta DB managing unit and recommending the music for the driver.

14. The non-transitory computer readable medium of claim 12, further comprising:
program instructions that classify the type of the stress by checking the state value of the conversion data; and
program instructions that classify the intensity of the stress for each type of stress by checking the state value of the conversion data.
